(19) United States
(12) Patent Application Publication
(10) Pub. No.: US 2026/0027907 A1
(43) Pub. Date: Jan. 29, 2026

(54) APPARATUS FOR AN INDUCTIVE CHARGING SYSTEM, AND INDUCTIVE CHARGING SYSTEM

(71) Applicant: Brusa Elektronik AG, Buchs (CH)

(72) Inventor: Lukas Böhler, Buchs (CH)

(21) Appl. No.: 19/152,303

(22) PCT Filed: Feb. 19, 2024
(86) PCT No.: PCT/EP2024/054103

§ 371 Date: Jul. 30, 2025

(30) Foreign Application Priority Data
Feb. 17, 2023 (DE) 10 2023 103 932.6

(51) Int. Cl. B60L 3/04; B60L 53/122; H02H 3/02; H02H 3/16

(52) U.S. Cl. CPC B60L 3/04; B60L 53/122; H02H 3/025; H02H 3/165; H02H 3/167

(57) ABSTRACT

A fault protection device for an inductive charging system, the device including an input terminal, a storage device for electrical energy, and an input safety device disposed between the input terminal and the storage device, wherein the input safety device has at least one safety element selected from the group of safety elements consisting of a residual current device (RCD), at least one safety switch, and a discharging element.

### CROSS REFERENCE TO RELATED APPLICATIONS

The present application is the U.S. National Phase of PCT/EP2024/054103, filed on 19 Feb. 2024, which claims priority to German Patent Application No. 10 2023 103 932.6, filed on 17 Feb. 2023, the entire contents of which are incorporated herein by reference.

### BACKGROUND

### Field

The invention relates to the technical field of inductive charging. In particular, the present invention relates to a device for an inductive charging system and an inductive charging system.

### Brief Discussion of Related Art

For the electric charging of a purely electric vehicle (EV) or a hybrid vehicle (PHEV, plug-in hybrid electric vehicle) which is powered by a combination of fuel and electrical energy, an inductive energy transfer system can be used if the charging is to be carried out in a contactless manner. In such a system, an alternating magnetic field is generated in the frequency range of 25 kHz . . . 150 kHz. It should be noted that outside this frequency band the limits for the emission of electromagnetic waves are defined by internationally valid standards. Although in principle a magnetic field is used to transfer energy, the fact that the magnetic field changes means that it is inherently an electromagnetic wave. However, due to the slow changes of field strengths, the electromagnetic wave used in inductive charging has a wavelength of multiple kilometers.

In order to comply with these emission limits, it is important to ensure that the alternating magnetic field used for energy transmission operates at a fundamental oscillation in the range of 25 kHz . . . 150 kHz and contains only very low harmonics. Therefore, filters are used to remove disturbing harmonics as much as possible. Furthermore, in order to comply with internationally valid standards and guidelines, it must be ensured that energy transmission only occurs when a specific quality of coupling to one another is achieved by setting a specific alignment of the coupling elements to one another, for example, using a positioning system as described in document EP 3 103 674 A1.

As a coupling element for the energy transfer, a GPM (ground pad module) or GA (ground assembly) with a primary coil is used on the stationary side and a CPM (car pad module) or CA (car assembly) with a secondary coil is used on the vehicle side. GA and CA form a transformer for coupling and energy transfer. The physical alignment of the coupling elements to each other is measured and adjusted via a positioning signal, e.g., a WLAN (wireless local area network). Different transmission paths and different transmission technologies are used for energy transfer and the transmission of the positioning signal.

Protection must be provided since the GA in particular is installed on public land and a DC (direct current) voltage is applied.

### SUMMARY

It can be considered to be an object of the present invention to enable effective protection from faults of an inductive charging system.

Accordingly, a device for an inductive charging system and an inductive charging system are specified.

The subject matter of the invention is specified by the features of the independent claims. Example embodiments and further aspects of the invention are specified by the dependent claims and the following description.

According to one aspect of the present invention, a device, in particular a protection device, for an inductive charging system is specified, including an input terminal, a storage device for electrical energy, an input safety device, wherein the input safety device is disposed between the input terminal and the storage device for electrical energy and wherein the input safety device has at least one safety clement, selected from the group of safety elements consisting of an RCD (residual current device), at least one safety switch, and a discharging element.

The storage device can be an element of the inductive charging system that stores electronic energy. Such storage devices can be coils and/or capacitors that are installed in the inductive charging system.

The input safety device may be designed in such a way that it dissipates a high charge of the storage device as far as possible within the device, in particular, within a housing of the device, such that a protective effect occurs toward the outside of the housing.

According to a further aspect of the present invention, the device further includes an output terminal and an output safety device, wherein the output safety device is disposed between the output terminal and the storage device for electrical energy and wherein the output safety device includes at least one safety element, selected from the group of safety elements consisting of an RCD, at least one safety switch, and a discharging element.

In other words, the protection of an output may be substantially structurally identical to the protection of the input.

According to yet another aspect of the present invention, the device includes an input terminal monitoring device and/or an output terminal monitoring device, wherein the input terminal monitoring device and/or the output terminal monitoring device is configured to detect a fault in a connecting element connected to it, for example, in a cable.

The input terminal monitoring device and/or an output terminal monitoring device can be designed as safety elements and may be triggered if it is detected that the connection, for example, a cable, between individual components and/or devices of the inductive charging system is corrupted and/or torn and the HV (high voltage) lines and/or the high-voltage lines are exposed. This can be detected by monitoring an electrical connection. This may be done by applying a measuring current, a measuring voltage, a measuring impedance, and/or a combination thereof. For monitoring purposes, a signal may be modulated onto the HV and/or LV (low voltage) lines. The LV line may carry a DC voltage that is lower than the DC voltage of the HV line.

The monitoring devices can also be constructed as a dedicated line, that is, substantially as a line laid parallel to the lines and/or cables of the inductive system.

Monitoring devices may be designed such that, if the electrical connection is interrupted, it can be assumed that the cable is broken and the HV lines are exposed and pose a hazard.

According to another aspect of the present invention, the device includes a cable shield and/or cable sheath, wherein the cable shield and/or cable sheath is connected to at least one of the input terminal and the output terminal.

On the one hand, the cable shield and/or cable sheath can protect a cable from physical contact. However, it can also carry a signal that can be used to detect a fault.

According to a further aspect of the present invention, the cable shield can be used for cable insulation monitoring by impressing a current into the cable shield.

If the current flow can no longer be detected, it can be assumed that there is a fault.

According to yet another aspect of the present invention, the at least one safety switch is used to disconnect the electrical energy storage device from the input terminal and/or from the output terminal.

In this way, if a fault is detected, it may be possible to prevent a dangerous voltage from being applied to a defective cable for too long.

According to another aspect of the present invention, the at least one safety switch is configured to connect the input terminal and/or the output terminal to the discharging element.

A dangerous voltage can be quickly dissipated in this way as well.

According to yet another aspect of the present invention, the at least one safety switch is configured to connect a current limiting element between the input terminal and the electrical energy storage device, between the output terminal and the electrical energy storage device, and/or between the input terminal and the output terminal.

The current limiting element may ensure that a high current flow is limited in the event of a fault.

According to another aspect of the present invention, the device is a ground assembly and/or a car assembly of an inductive charging system.

An inductive charging system may be protectable at different places in this way.

According to yet another aspect of the present invention, at least one of the input terminal and the output terminal is configured for magnetic coupling.

In an inductive charging system, one component may establish the magnetic coupling between the ground assembly and the car assembly.

According to another aspect of the present invention, an inductive charging system is described including at least one of the devices according to the invention.

An inductive charging system may have a chain of devices that can be connected by cables. Using the invention according to the invention may help protect against dangers posed by these connections of the devices.

### BRIEF DESCRIPTION OF THE DRAWINGS

Further example embodiments of the present invention are described hereinafter with reference to the figures.

FIG. 1 shows an inductive charging system according to an example embodiment of the present invention.

FIG. 2 shows a device protection for a better understanding of the present invention.

FIG. 3 shows a device protection for devices with small and large energy stores for a better understanding of the present invention.

FIG. 4 shows a block diagram of an inductive charging system according to an example embodiment of the present invention.

FIG. 5 shows a block diagram of a GA according to an example embodiment of the present invention.

FIG. 6 to FIG. 9 show various configurations for input and/or output safety devices according to an example embodiment of the present invention.

FIG. 10 shows a circuit diagram of a motor control according to an example embodiment of the present invention.

FIG. 11 shows another circuit diagram of a motor control according to an example embodiment of the present invention.

FIG. 12 shows a circuit diagram of a protection device according to an example embodiment of the present invention.

### DETAILED DESCRIPTION

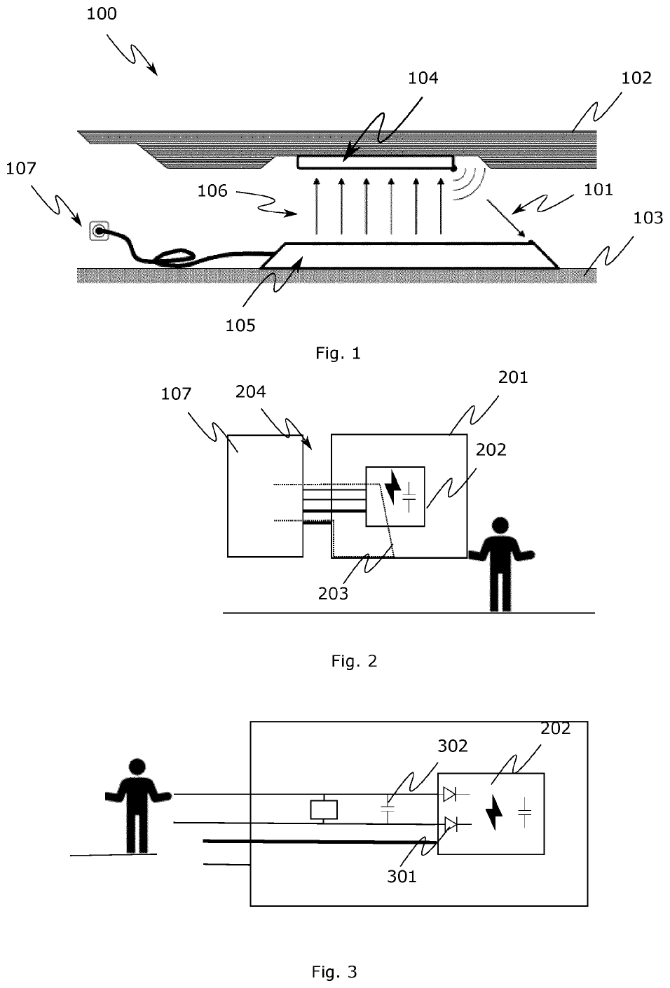

The illustrations in the figures are schematic and not to scale. In the following description of FIG. 1 to FIG. 12, the same reference numerals are used for the same or corresponding elements.

FIG. 1 shows an inductive charging system 100 or system 100 for energy transfer according to an example embodiment of the present invention. This shows a lateral view of a system for contactless charging of an electric vehicle. Below a vehicle chassis 102, there is a car assembly (CA) 104 or a car pad module (CPM) 104 which serves to supply the vehicle 102 with power. A magnetic field which is inductively provided by a ground assembly (GA) 105 or a ground pad module (GPM) 105 fixedly mounted on a floor 103 is used for energy transmission. The energy required for charging is taken from the main terminal 107, which can be either alternating current (AC) or direct current (DC). A separate connection 101 is used for communication between CPM 104 and GPM 105, which connection can use a radio protocol such as WLAN (wireless LAN) or NFC, for example. This connection can be used as a feedback channel 101 or as a communication channel 101 through which the CA 104 and the GA 105 can exchange information. Both the magnetic field for energy transmission 106 and the radio signal 101 are electromagnetic waves, but they have different frequencies.

A system for inductive energy transfer is considered, which can be used for contactless charging of an electric vehicle. In such a system, an alternating magnetic field 106 is generated in the frequency range of 25 kHz . . . 150 kHz. It should be noted that outside this frequency band the limits for the emission of electromagnetic waves are defined by internationally valid standards. In order to comply with these limits, it is critical that the alternating magnetic field 106 operates at the fundamental oscillation in the range of 25 kHz . . . 150 kHz and contains only very low harmonics.

FIG. 2 shows a device protection for a better understanding of the present invention.

A device 201 with a storage device 202 for electrical energy is connected to the main terminal 107 via three phases 204. A fault has occurred inside device 201, which fault is diverted via the fault connection 203.

Many power devices or high-voltage devices are protected by the same high-voltage protection concept. The protective mechanisms summarize various categories, for example, electrical insulation, electrical shielding, or earth connection, an RCD (residual current device), overvoltage protection, and/or a discharging mechanism. These are based on the concept that a device is substantially insulated. Thus, if a fault occurs, either a housing and/or chassis 201 is electrically insulated, has sufficient distance from live parts and/or is connected to the protective ground 501 to bring a current back to the main terminal 107 and/or grid 107, for example, via the fault connection 203, and thereby trigger a surge protector.

FIG. 3 shows a device protection for devices with small and large energy stores for a better understanding of the present invention.

In order to avoid endangering or even injuring people when they unplug a power strip or touch the plug, active components in a plug that can be touched are to be discharged within a definable time.

In order to reduce the energy that may need to be discharged, a diode 301 and/or another separation element 301 is used to separate large internal energy stores 202 from small energy stores 302 that are directly connected to the active connector, for example, EMC filters 302.

For example, RCDs can detect a current flowing to ground 501 and open the connection between main terminal 107, grid 107, and/or mains 107, thereby disconnecting the main voltage from the device. Surge protection does not directly protect people from electric shock, but it prevents a short-circuit current from becoming a source of risk, such as the risk of fire or explosion.

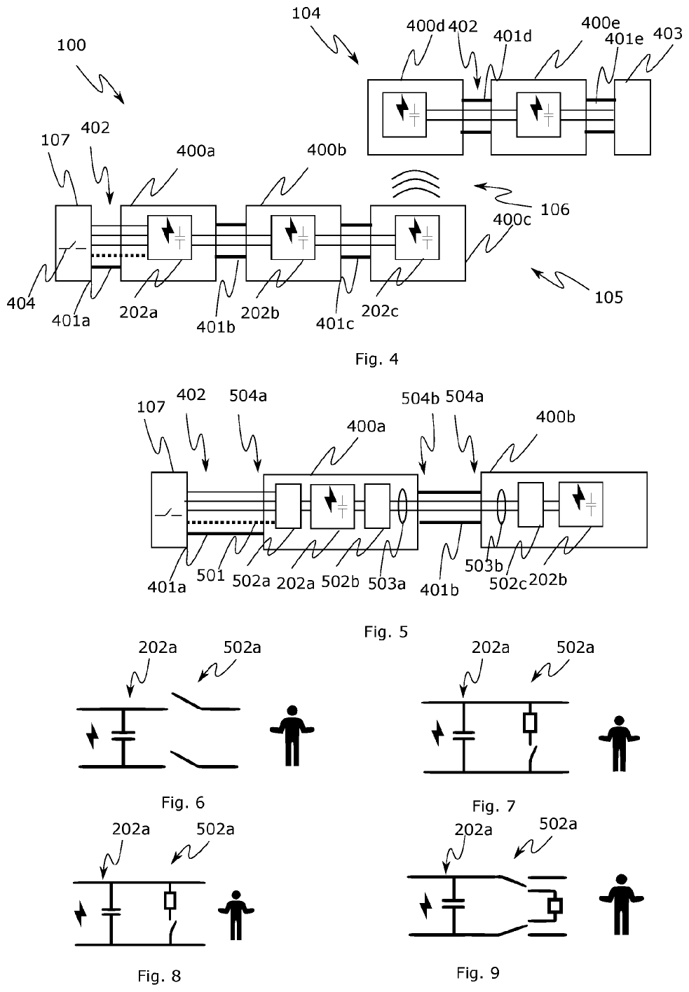

FIG. 4 shows a block diagram of an inductive charging system 100 according to an example embodiment of the present invention.

Here, starting from the main power supply 107, several protection devices 400a, 400b, 400c of a GA 105 are connected to the RCD 404. The GA 105 is connected to a CA 104 via the magnetic field 106. The CA 104 has the protection devices 400d, 400e which are connected to the vehicle battery 403.

The protection devices are connected to cables 401a, 401b, 401c on the GA 105 side and to cables 401d, 401e on the CA 104 side. The phases 402, which constitute the current-carrying parts, are guided in the cables 401a, 401b, 401c, 401d, 401e.

It is not only protection against the risk of fire and explosion that must be ensured in an inductive charging system 100. Instead, it must be taken into account that the GA 105, in particular, with its active components, is located in a parking lot and is connected to the main terminal 107. The GA 105 is exposed to very harsh conditions. It even has to be taken into account that a snow plow hits it.

The ground assembly 105 may include a plurality of components 202a, 202b, 202c, 202d, 202e with energy storage devices and may include one, two, three, or more boxes. The energy stores may also contain parasitic energy stores.

The inductive charging system 100 has a safety concept adapted to the area of application, which takes into account that the inductive charging system 100 is exposed to harsh conditions and is located in a publicly accessible space. In addition to the harsh environment in which the inductive charging system 100 is used, it must be taken into account that the connections between the modules 400a, 400b, 400c, 400d, 400e carry a direct voltage or DC voltage. This results in a high level of risk and major problems when it comes to interrupting short-circuit currents.

FIG. 5 shows a block diagram of a GA 105 with protection devices 400a, 400b according to an example embodiment of the present invention.

The protection devices 400a, 400b are substantially constructed in the same way. A protection device 400a, 400b for an inductive charging system 100 has an input terminal 504a, a storage device 202a, 202b for electrical energy and an input safety device 502a, 502c, 503b. The input safety device 502a, 502c, 503b is disposed between the input terminal 504a and the storage device 202a, 202b for electrical energy and the input safety device 502a, 502c, 503b has at least one safety element selected from the group of safety elements consisting of an RCD (residual current device), at least one safety switch, and a discharging element.

In addition, a plurality of RCDs can be used. A safety element can also be designed as a shield of the cable and/or have a switch to open contacts, an element for rapid discharge, and an element which is implemented according to the principle of an “enforced standard safety element.”

An inrush current limiting element is often located at the mains input of a device. The element contains a resistor or similar element to limit the current and a relay that short-circuits the current limit during use of the device. In conventional power electronics, there is no physical separation between the mains and the device. The reason for this is that the residual current device in the infrastructure interrupts the flow of electricity in the event of an insulation failure. Conventionally, there is typically only the small charging relay in parallel with precharging resistors in series with PFC diodes. In an inductive charging system with multiple boxes and an input relay which can be a forced current relay, the current coming from the mains can be limited in the event of an insulation fault detected between the boxes. The idea is to reinforce the precharging relay which is used to limit the input currents and to use it to safely interrupt the hazard of the corresponding current path.

The safety devices may also include mechanisms for checking for cable breaks.

The protection devices 400a, 400b further include an output terminal 504b, in particular, a magnetic coupling device, and an output safety device, wherein the output safety device 502b, 503a is disposed between the output terminal 504b and the storage device 202a for electrical energy, and wherein the output safety device has at least one safety element, selected from the group of safety elements consisting of an RCD, at least one safety switch, and a discharging element.

Thus, specific safety elements, for example, input safety devices 502a, 502c, 503b and output safety devices 502b, 503a, are provided at the inputs 504a and outputs 504b of an inductive charging system in order to protect the connections between the individual protection devices 400a, 400b and/or components of the inductive system 100.

The connections between the individual protection devices 400a, 400b are often cables 401a, 401b, which often do not even have a housing to protect against the harsh environment.

The grounding 501 is also located between the main terminal 107 and the first module 400a.

FIG. 6 to FIG. 9 show various configurations for input and/or output safety devices 502a, 502b, 502c according to an example embodiment of the present invention.

The input and/or output safety devices 502a, 502b, 502c may be implemented as switches that isolate the storage device 202a, 202b, 202c, 202d, 202e from external cables 401a, 400b, 400c, 400d, 400e, as shown in FIG. 6.

The input and/or output safety devices 502a, 502b, 502c may be designed as switches forming a network with a high discharge time, which are configured to convert the electrical energy into thermal energy and thus consume the electrical energy within the housing, for example. FIG. 7 shows an example of energy conversion by connecting a resistor in parallel with a capacitor.

Combinations of both principles, switching off the connection and destroying electrical energy by converting it into heat are also possible, as FIG. 8 shows. When the resistor is switched on, the circuit is simultaneously disconnected.

Another safety device may provide a feature that, after one of the input and/or output safety devices 502a, 502b, 502c has triggered and if an electrical-heat conversion has been carried out, waits until the discharging element, for example, a resistor, has cooled down again before it can be switched on again.

The switch of an input and/or output safety device 502a, 502b, 502c can be implemented as a relay. The relay can be implemented as an open-closed switch or as a changeover switch.

In addition to the input and/or output safety device 502a, 502b, 502c and/or the safety element 502a, 502b, 502c, an RCD functionality 404, 503a, 503b may be provided. The RCD functionality 404, 503a, 503b may be located within the inductive charging system between the output safety device 502b and output terminal 504b, but also between input terminal 504a and input safety device 502c. The RCD functionality 503a, 503b may thus be provided as a connecting link between two modules 400a, 400b, 400c, 400d, 400e, but may also be used to connect to the primary RCD in the main terminal 107.

The shield of a cable can also be used as an input safety device 502a, 502c and/or as an output safety device 502b. The shield provides good EMC (electromagnetic compatibility) protection and contributes to safety by allowing a ground current if the damaged cable is short. This short current can be detected by an RCD.

If the cable has a shield, a test current can be impressed into the shield to determine whether the shield is sufficiently insulated. This current measurement can be used as an additional level of safety in that it can be used to detect broken cables.

For example, a shield test current is impressed into the shield of the cable 401b.

The current flow in the cable shield can be used to detect whether there is a fault in the connection and/or in a connecting element, particularly in the cable 401a, 401b, 401c, 401d, 401e. The safety elements are intended to be triggered if it is detected that the connection and/or the cable 401a, 401b, 401c, 401d, 401e between the devices is corrupted and/or tom and the HV lines 402 are exposed.

This can be detected by monitoring an electrical connection. This can be done by applying a measuring current, a measuring voltage, a measuring impedance, and/or a combination thereof. The signal, for example, a current in the shield, can be modulated onto the HV or LV lines or flow in a dedicated line. If the electrical connection is interrupted, it can be assumed that the cable is broken and the HV lines are exposed.

A method may be provided which detects the interruption of the current flow and triggers the input safety device 502a, 502c and/or the output safety device 502b.

Often, a device circuit includes an inrush current limiting element at the input of the circuit. Such an element has a resistor or a similar element that can limit a current. It also has a relay that short-circuits the current limit while the device is in use.

However, in power electronics, there is often no physical interruption between the grid 107 or the main terminal 107 and the device. In such an infrastructure, the RCD 404 is designed to interrupt the power flow in case of a break in the insulation.

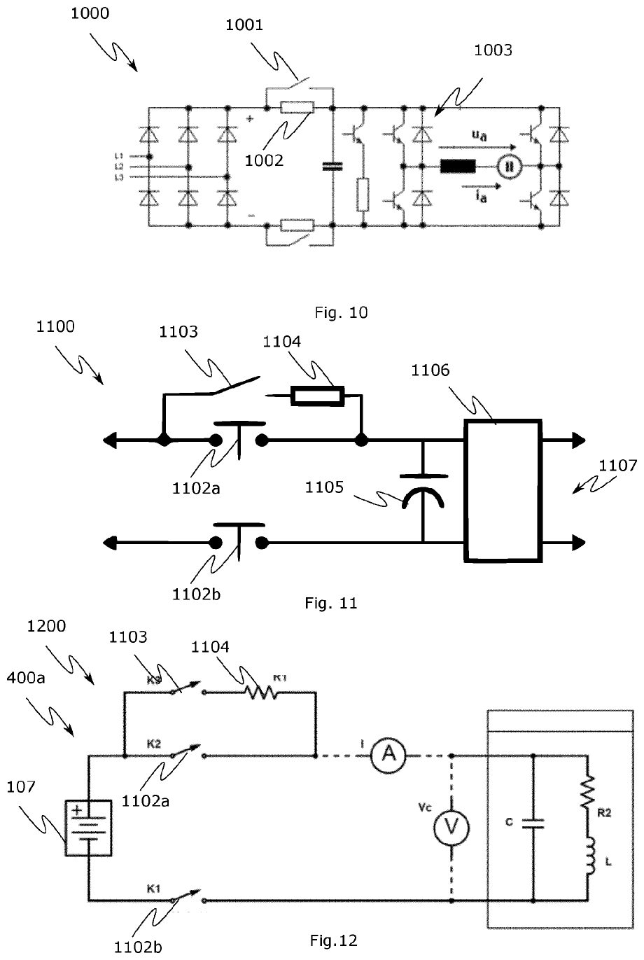

FIG. 10 shows a circuit diagram of a motor control 1000 according to an example embodiment of the present invention.

For example, only a small precharging relay or a precharge relay 1001 is connected in parallel with a precharge resistor or precharge resistor 1002 at the input of a circuit. This parallel circuit may be connected in series with the PFC (power factor correction) diodes 1003.

The combination of precharge relay 1001 and precharge resistor 1002 can be provided in both an input circuit and an output circuit.

FIG. 11 shows another circuit diagram of a motor control 1100 according to an example embodiment of the present invention.

Starting from a power source 1101, a main relay 1102a, 1102b is provided in the input terminal and the output terminal. The main relay 1102a, which is provided in the input circuit, is bridged by a series circuit consisting of precharge relay 1103 and precharge resistor 1104. This is followed by a parallel connection of a filter capacitor 1105, the motor control unit 1106, and an output terminal for connecting a load 1107.

FIG. 12 shows a circuit diagram 1200 of a protection device 400a, 400b, 400c, 400d, 400e according to an example embodiment of the present invention.

In the case of an inductive charging system 100 which has several boxes, devices and/or protection devices 400a, 400b, 400c, 400d, 400e connected in series, a current consumption relay 1103 is provided at the input terminal 504a as a safety device 502a, 502b, 502c. The current consumption relay 1103 is designed as a precharge relay 1103 and is disposed in series with the precharge resistor 1104. In parallel to the series circuit, the main relay 1102a, 1102b is provided in both the input branch and the output branch of the input terminal. The main relay 1102a in the input branch can be bridged using the series circuit.

The relay 1103 in the input terminal 504a can be used to interrupt the current from the main terminal 107 if an insulation fault is detected, for example.

Thus, the precharge relay 1103 and the precharge resistor 1104 can be used not only when switching on but also when a fault is detected.

This use as a protective element may be controlled by the input safety device 502a, 502c and/or the output safety device 502b.

In addition, it is to be noted that “comprising”, “including”, and “having” do not exclude any other elements or steps and that “one” or “a” does not exclude a plurality. Furthermore, it is to be noted that features or steps that have been described with reference to one of the above example embodiments can also be used in combination with other features or steps of other example embodiments described above. Reference numerals in the claims are not to be regarded as a limitation.

### LIST OF REFERENCE NUMERALS

100 inductive charging system
101 feedback channel
102 vehicle chassis
103 floor
104 car assembly
105 ground assembly
106 alternating magnetic field
107 mains terminal
201 device
202a, 202b, 202c,
202d, 202e storage device
203 fault connection
204 phases
301 separation element
302 small energy store
400a, 400b, 400c,
400d, 400e protection device
401a, 401b, 401c,
401d, 401e cable
402 phases
403 vehicle battery
404 RCD
501 grounding
502a, 502c input safety device
503b input safety device
502b output safety device
503a output safety device
504a input terminal
504b output terminal
1000 motor control circuit
1001 precharge relay
1002 precharge resistor
1003 PFC diodes
1100 motor control
102a, 1102b main relay
1103 precharge relay
1104 precharge resistor
1105 filter capacity,
1106 motor control unit
1107 load connection
1101 energy source
1200 circuit diagram of a protection device
1201 relay

1. A fault protection device for an inductive charging system, the device comprising:
an input terminal;
a storage device for electrical energy; and
an input safety device disposed between the input terminal and the storage device, wherein the input safety device has at least one safety element selected from the group of safety elements consisting of:
a residual current device (RCD),
at least one safety switch; and
a discharging element.

2. The device of claim 1, further comprising:
an output terminal, and an output safety device disposed between the output terminal and the storage device, wherein the output safety device comprises at least one safety element selected from the group of safety elements consisting of:
an RCD;
at least one safety switch; and
a discharging element.

3. The device of claim 2, further comprising:
an input terminal monitoring device; and/or an output terminal monitoring device, the input terminal monitoring device and/or the output terminal monitoring device being configured to detect a fault in a connecting element connected thereto.

4. The device of claim 2, further comprising a cable shield and/or cable sheath, wherein the cable shield and/or cable sheath is connected to at least one of the input terminal and the output terminal.

5. The device of claim 4, wherein the cable shield is used for cable insulation monitoring by impressing a current into the cable shield.

6. The device of claim 2, wherein the at least one safety switch is used to disconnect the storage device from the input terminal and/or from the output terminal.

7. The device of claim 2, wherein the at least one safety switch is configured to connect the input terminal and/or the output terminal to the discharging element.

8. The device of claim 2, wherein the at least one safety switch is configured to connect a current limiting element between the input terminal and the storage device, between the output terminal and the storage device, and/or between the input terminal and the output terminal.

9. The device of claim 1, wherein the device is a ground assembly and/or a car assembly of the inductive charging system.

10. The device of any one of claim 2, wherein at least one of the input terminal and the output terminal is configured for magnetic coupling.

11. An inductive charging system comprising a fault protection device, the device comprising:
an input terminal;
a storage device for electrical energy; and
an input safety device disposed between the input terminal and the storage device, wherein the input safety device has at least one safety element selected from the group of safety elements consisting of:
a residual current device (RCD);
at least one safety switch; and
a discharging element.

12. The system device of claim 1, wherein the device further comprises:
an output terminal; and
an output safety device disposed between the output terminal and the storage device, wherein the output safety device comprises at least one safety element selected from the group of safety elements consisting of:
an RCD;
at least one safety switch; and
a discharging element.

13. The system of claim 12, further comprising:
an input terminal monitoring device; and/or
an output terminal monitoring device, the input terminal monitoring device and/or the output terminal monitoring device being configured to detect a fault in a connecting element connected thereto.

14. The system of claim 12, further comprising a cable shield and/or cable sheath, wherein the cable shield and/or cable sheath is connected to at least one of the input terminal and the output terminal.

15. The system of claim 14, wherein the cable shield is used for cable insulation monitoring by impressing a current into the cable shield.

16. The system of claim 12, wherein the at least one safety switch is used to disconnect the storage device from the input terminal and/or from the output terminal.

17. The system of claim 12, wherein the at least one safety switch is configured to connect the input terminal and/or the output terminal to the discharging element.

18. The system of claim 12, wherein the at least one safety switch is configured to connect a current limiting element between the input terminal and the storage device, between the output terminal and the storage device, and/or between the input terminal and the output terminal.

19. The system of claim 11, wherein the device is a ground assembly and/or a car assembly of the inductive charging system.

20. The system of claim 12, wherein at least one of the input terminal and the output terminal is configured for magnetic coupling.
